(19) United States
(12) Patent Application Publication
(10) Pub. No.: US 2010/0108675 A1
(43) Pub. Date: May 6, 2010

(54) MEDICAL WASTE CONTAINER

(76) Inventors: Cynthia R. Meissen, Atlanta, GA (US); Kyle L. Baltz, Redondo Beach, CA (US)

Correspondence Address: CARLSON, GASKEY & OLDS, P.C., 400 WEST MAPLE ROAD, SUITE 350, BIRMINGHAM, MI, 48009, US

(21) Appl. No.: 12/612,811

(22) Filed: Nov. 5, 2009

Related U.S. Application Data
(60) Provisional application No. 61/111,613, filed on Nov. 5, 2008.

(51) Int. Cl. B65D 51/18; B23P 17/04

(52) U.S. Cl. 220/254.3; 29/428

(57) ABSTRACT

In one example of the present invention, a medical waste container assembly includes a container having a base portion and an upper edge and a secondary lid located adjacent the upper edge of the container having a door hingeably attached to the secondary lid with the door being trimmed from a portion of the secondary lid.

This application claims priority to U.S. Provisional Application No. 61/111,613 which was filed on Nov. 5, 2008.

### BACKGROUND OF THE INVENTION

This disclosure generally relates to a lid and a base for a medical waste disposal container.

Many types of containers have been used to store medical waste and protect the patient or health care professional from the waste product stored inside the container. The waste product may include biological material, medical devices, or other similar materials.

### SUMMARY OF THE INVENTION

In one example of the present invention, a medical waste container assembly includes a container having a base portion and an upper edge and a secondary lid located adjacent the upper edge of the container having a door hingeably attached to the secondary lid with the door being trimmed from a portion of the secondary lid.

In another particular example shown, the container assembly includes a container with a base portion and an upper. A secondary lid is located adjacent the upper edge of the container having a door hingeably attached to the secondary lid and an activation member that engages the door.

The lid and base member may be formed by trimming a first member to produce a lid member and trimming a second member to produce a base member.

A lid for the container is formed by trimming a member to form a door and a lid. The door is rotated relative to the lid and attached to the lid.

In another example, the lid includes a lid member and a door pivotably attached to the lid member, wherein the door is trimmed from a portion of the lid member.

### BRIEF DESCRIPTION OF THE DRAWINGS

The various features and advantages of the disclosed examples will become apparent to those skilled in the art from the following detailed description. The drawings that accompany the detailed description can be briefly described as follows:

FIG. 1 illustrates a perspective view of a medical waste container system with a first container.

FIG. 2 illustrates a perspective view of the medical waste container system with a second container.

FIG. 3 illustrates a perspective view of the medical waste container system with a door on a secondary lid in an open position.

FIG. 4 illustrates an enlarged cross sectional view of the door and the secondary lid.

FIG. 5 illustrates a bottom perspective view of the container.

FIG. 6 illustrates a perspective view of the secondary lid.

FIG. 7 illustrates a perspective view of the secondary lid with an activation rod.

FIG. 8 illustrates a perspective view of the secondary lid and activation rod with the door in the open position.

FIG. 9 illustrates a perspective view of the secondary lid and activation rod located on the container.

FIG. 10 illustrates a perspective view of the secondary lid and activation rod located on the container with the door in an open position.

FIG. 11 illustrates a perspective view of an alternative lid and activation rod located on a container.

FIG. 12 illustrates a front view of the alternative lid and activation rod of FIG. 11.

FIG. 13 illustrates a side view of the alternative lid and activation rod of FIG. 11.

FIG. 14 illustrates a perspective view of another example medical waste container system.

FIG. 15 illustrates a perspective view of the medical waste container system of FIG. 14 with a door in an open position.

FIG. 16 illustrates an exploded perspective view of the medical waste container system of FIG. 14.

FIG. 17 illustrates a perspective view of a universal member.

FIG. 18 illustrates an exploded perspective view of a secondary lid of the medical waste container system of FIG. 14.

FIG. 19 illustrates a perspective view of the secondary lid of FIG. 18.

FIG. 20 illustrates a top view of the secondary lid of FIG. 18.

FIG. 21 illustrates a bottom view of the secondary lid of FIG. 18.

FIG. 22 illustrates a front view of the secondary lid of FIG. 18.

FIG. 23 illustrates a side view of the secondary lid of FIG. 18.

FIG. 24 illustrates a perspective view of the door on the secondary lid of FIG. 18 in the open position.

FIG. 25 illustrates a side view of the door and secondary lid of FIG. 24.

FIG. 26 illustrates a front view of the door and secondary lid of FIG. 24.

FIG. 27 illustrates a top view of the door and secondary lid of FIG. 24.

FIG. 28 illustrates a cross sectional view of the door and secondary lid of FIG. 24 taken along line C-C of FIG. 27.

FIG. 29 illustrates a perspective view of a base member of the medical waste container system of FIG. 14.

FIG. 30 illustrates a front view of the base member of FIG. 29.

FIG. 31 illustrates a side view of the base member of FIG. 29.

### DESCRIPTION OF THE PREFERRED EMBODIMENTS

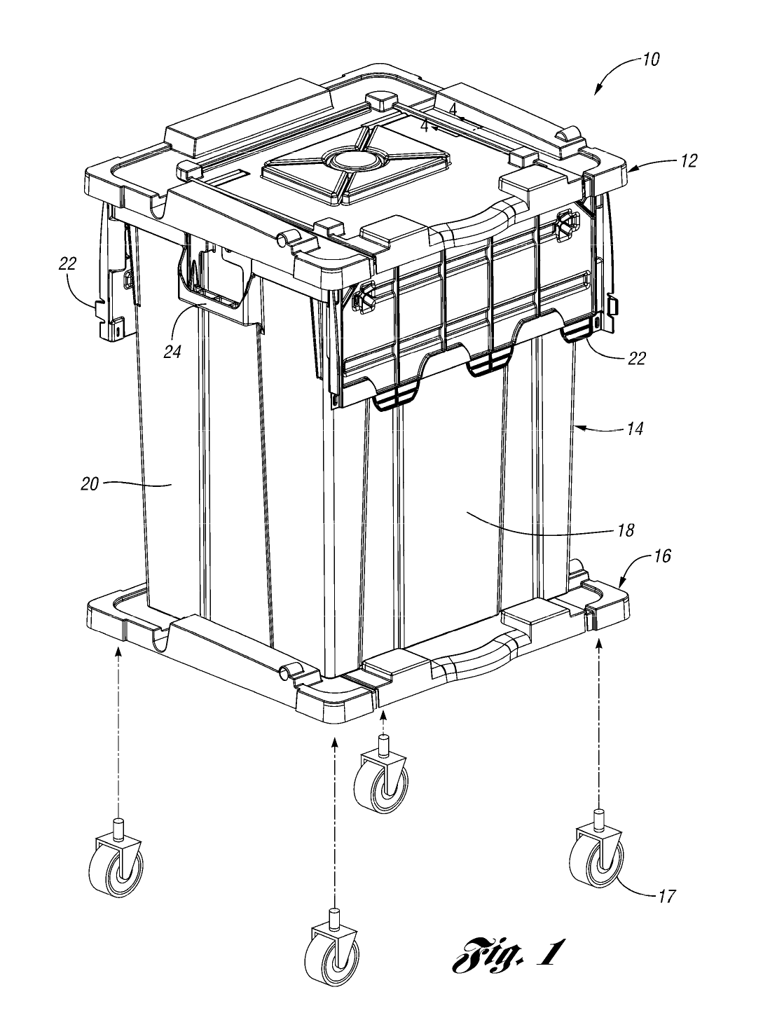

A medical waste container system 10 is shown in FIG. 1 including a secondary lid 12 on a known attached lid container 14, optionally supported on a base 16, optionally having casters 17. The medical waste could include biological material, medical devices, or other medical waste materials. The container 14 includes side walls 18 and end walls 20 and a pair of lids 22 hingeably secured to upper ends of the side walls 18. Handles 24 are formed on the end walls 20. It is known to provide some secondary lid on an existing attached lid container 14 when a bag or liner is placed in an open container 14, so the attached lids 22 do not have to be closed. However, the present invention provides several novel features in the secondary lid 12 and base 16.

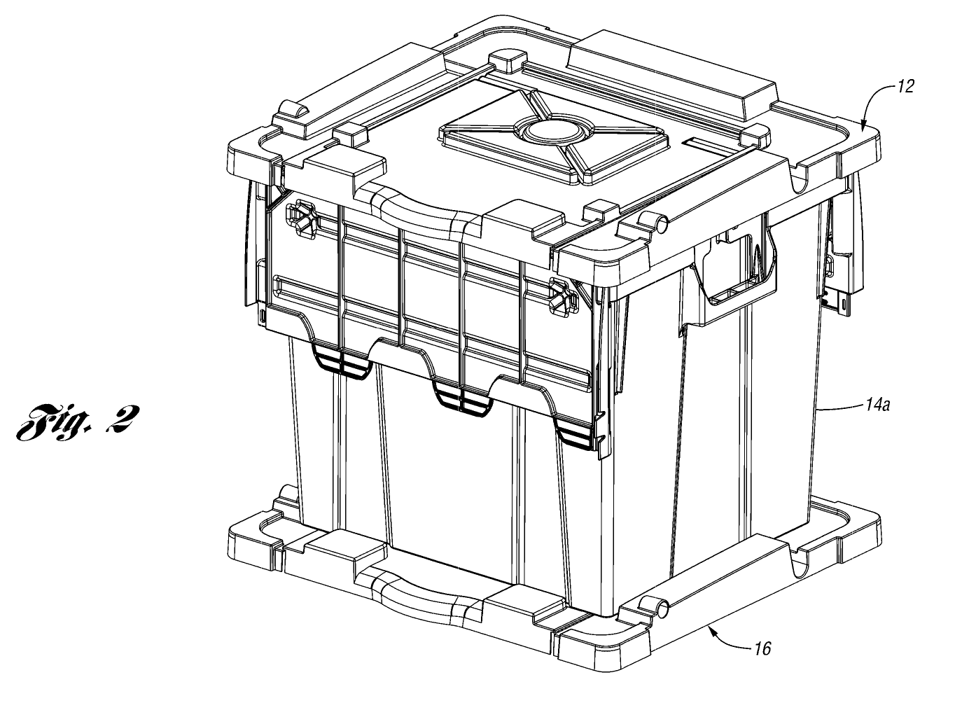

Referring to FIG. 2, the secondary lid 12 and base 16 can also be used with a different sized container 14a as part of a larger system.

The secondary lid 12 may be injection molded or thermo-formed. As shown, the secondary lid 12 simply rests on the upper edges of the container 14, but could alternatively snap-fit to the upper edges of the container 14 or otherwise be removably secured.

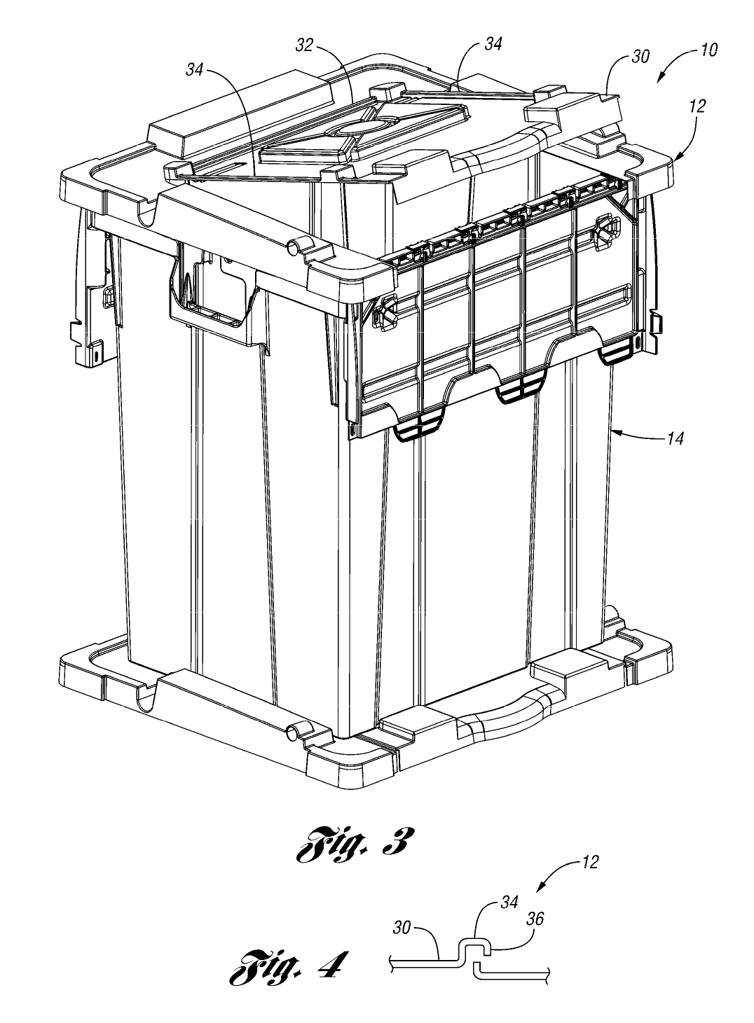

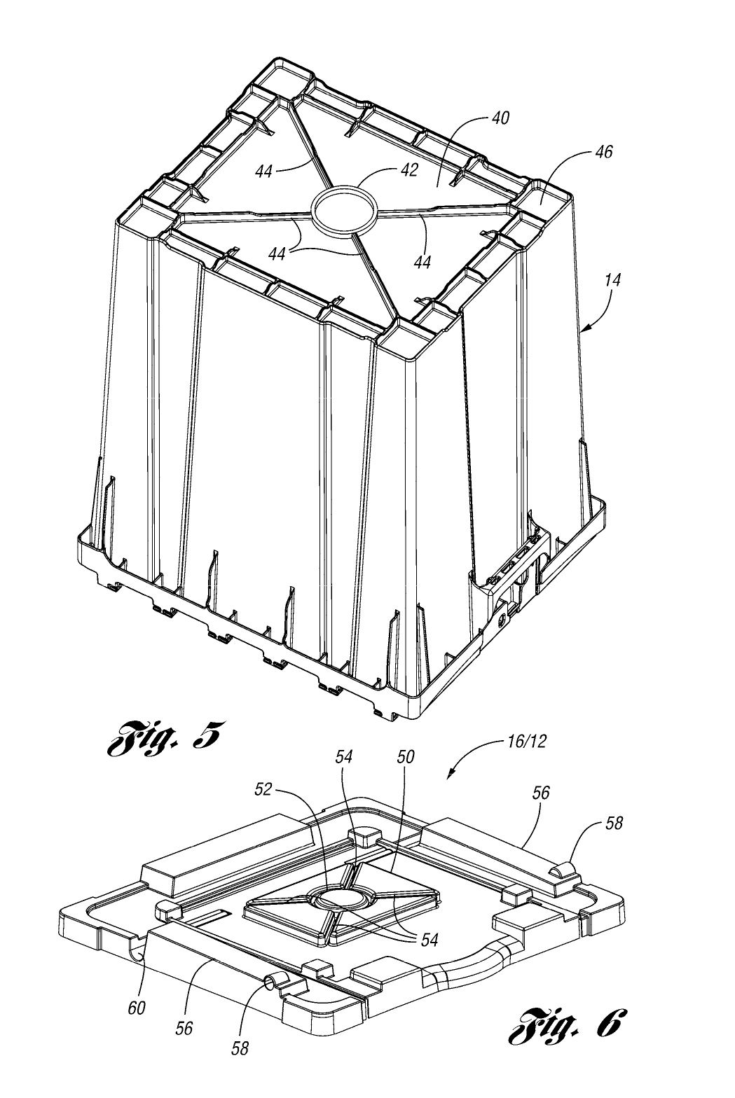

FIG. 3 illustrates the secondary lid 12 with the door 30 open, pivoting on a living hinge 32. In the embodiment shown, the door 30 includes an outer peripheral edge of the secondary lid 12; however, optionally, the door 30 could be formed entirely within the outer edge of the secondary lid 12. Referring to FIG. 4 as well as FIG. 3, the door 30 is preferably formed in the secondary lid 12 by forming a peripheral raised portion 34, which includes a vertical wall portion 36. After molding or thermo-forming the secondary lid 12, a cut is made through the vertical wall portion 36 to separate the door 30 from the remainder of the secondary lid 12. Because the cut is made in the vertical wall portion 36, the material removed from the secondary lid 12, from the vertical wall portion 36 will not leave a gap between the door 30 and the rest of the secondary lid 12. Rather, the door 30 will simply pivot downward to close the gap, such that the door 30 rests on the remainder of the secondary lid 12.

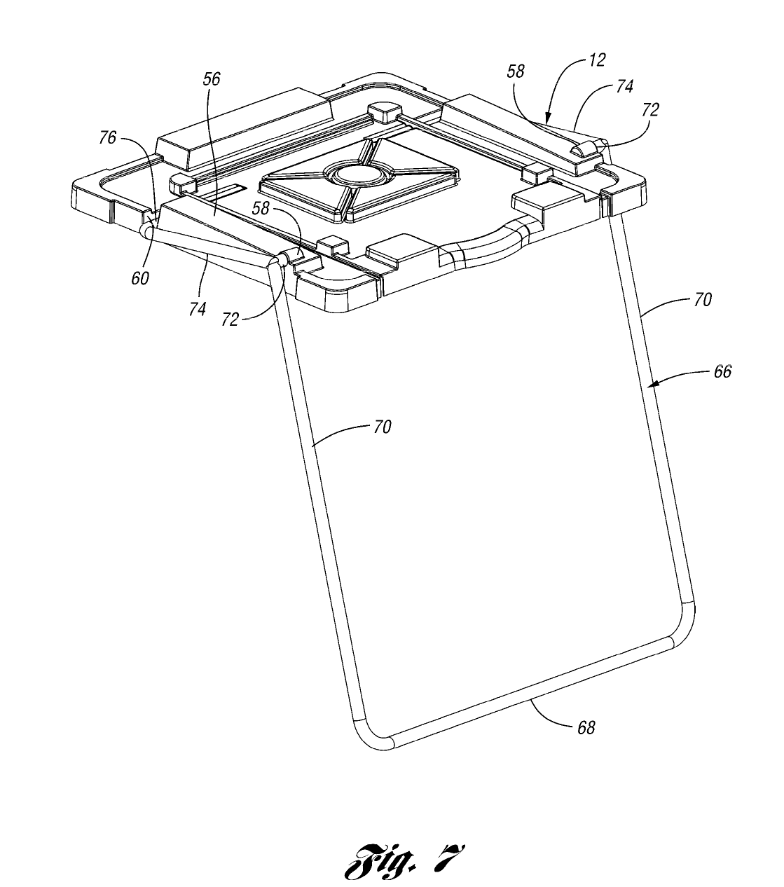

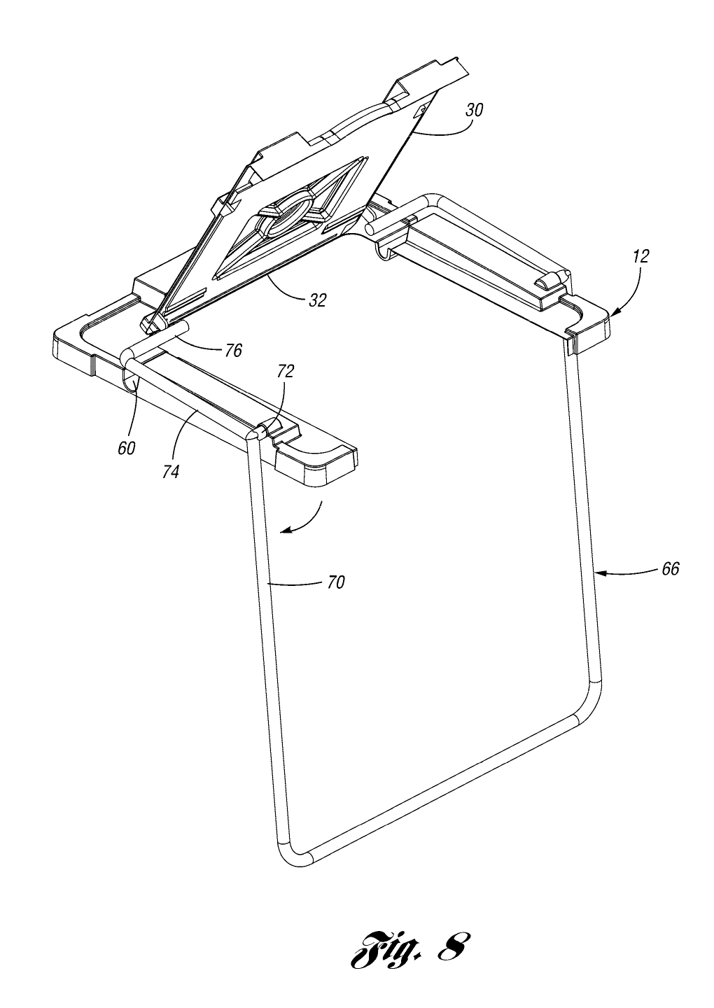

FIG. 5 shows the bottom of the container 14. The base 40 of the container 14 includes a rib pattern including a central, annular rib 42 and a plurality of radial ribs 44 extending outwardly therefrom. The particular configuration is not critical other than it could be complementary to a pattern of recesses in the top of the secondary lid 12, as shown in FIG. 6. A raised portion 50 in the secondary lid 12 includes an annular recess 52 having radial recesses 54 extending outwardly therefrom. The pattern permits interlocking of the ribs 42, 44 with the recesses 52, 54 and permits the ribs 42, 44 to be provided on different sized containers 14 and 14a.

As also shown in FIG. 6, end edges of the secondary lid 12 include raised portions 56 having a raised semi-cylindrical portion 58 toward a front of the secondary lid 12. A semi-cylindrical recess 60 is formed toward the rear of secondary the lid 12 behind the raised portions 56.

As shown in FIG. 7, this allows for an optional hands-free activation member 66. The activation member 66 includes a lower horizontal portion 68 from which two forward portions 70 extend upwardly to a pivot pin 72 that is received in an opening formed in the raised portion 56 (in particular, the semi-cylindrical portion 58) of the secondary lid 12. Rearward portions 74 extend rearwardly from the pivot pin 72 to a pair of inwardly directed portions 76 received in the recesses 60.

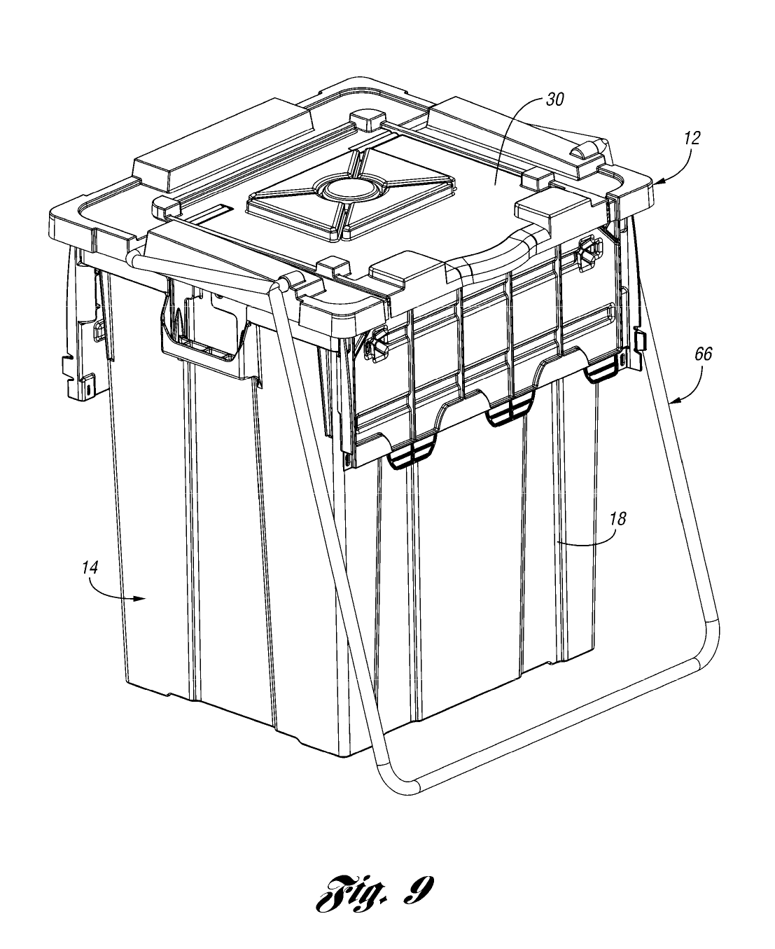

As shown in FIG. 8, by pivoting the rod 66 inward, the pivot pin 72 pivots in the secondary lid 12, causing the inwardly directed portions 76 to lift out of the recesses 60 and lift the door 70.

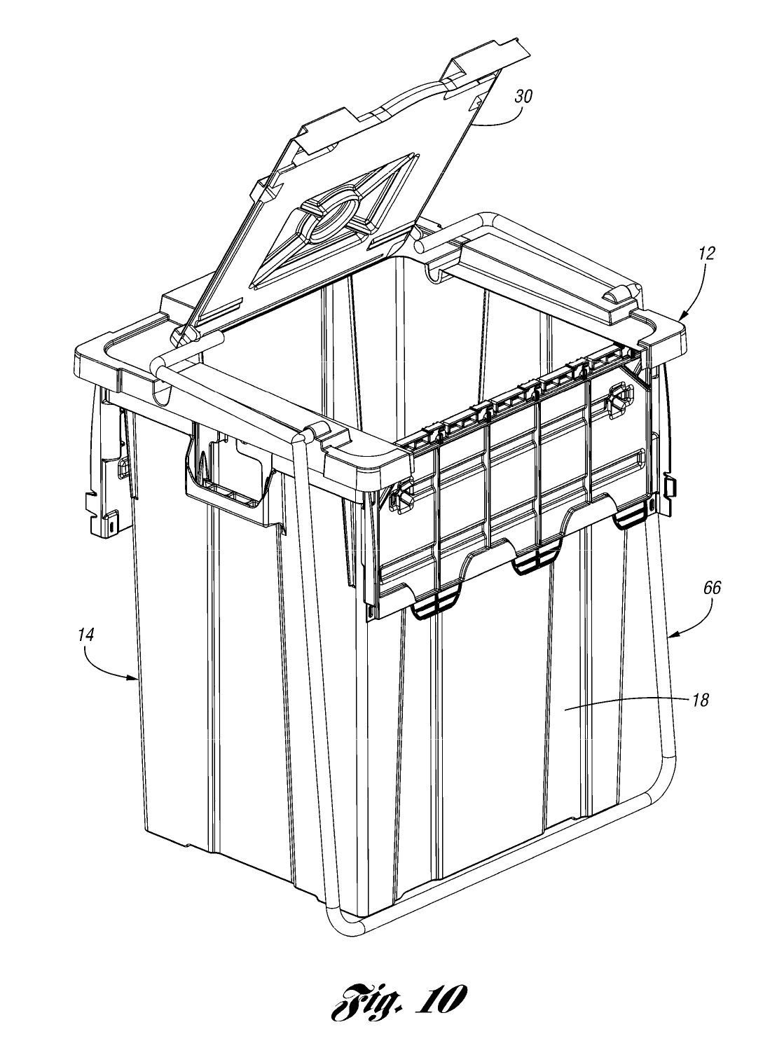

Thus, as shown in FIG. 9, the secondary lid 12 and rod 66 can provide hands-free activation of the door 30 without any modification to the container 14. No holes need be formed in the container 14 itself in order to provide the hands-free activation. Further, the hands-free activation of the door 30 can be provided to existing containers 14 without modification.

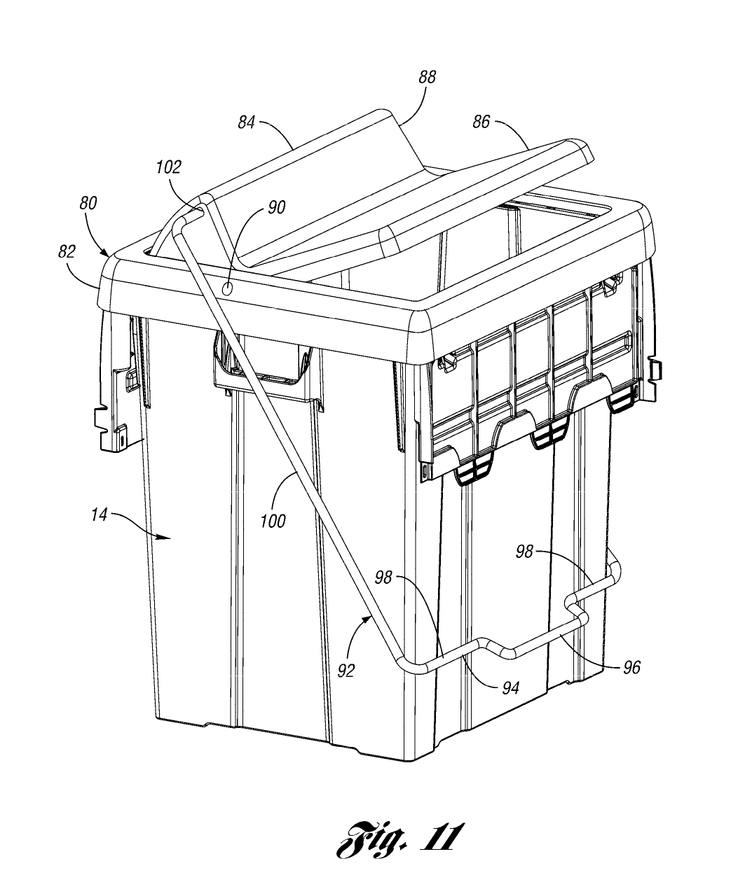

FIG. 10 illustrates the container 14 and secondary lid 12 with the rod 66 moved toward the side wall 18, thus activating the door 30.

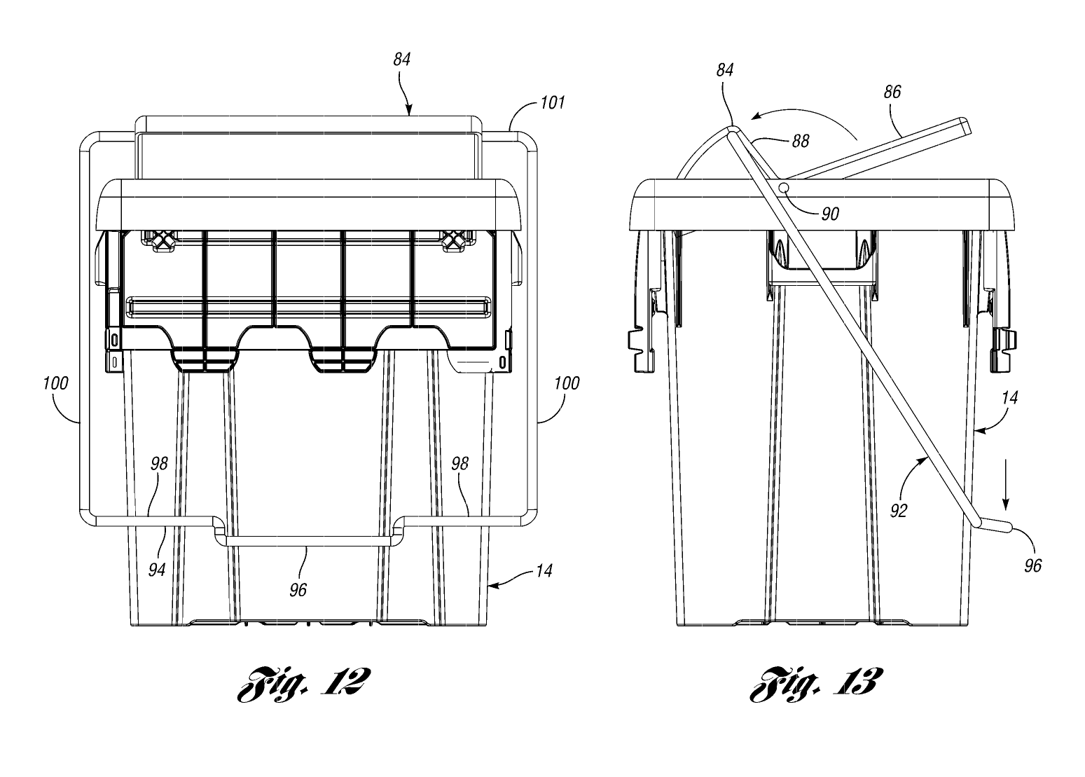

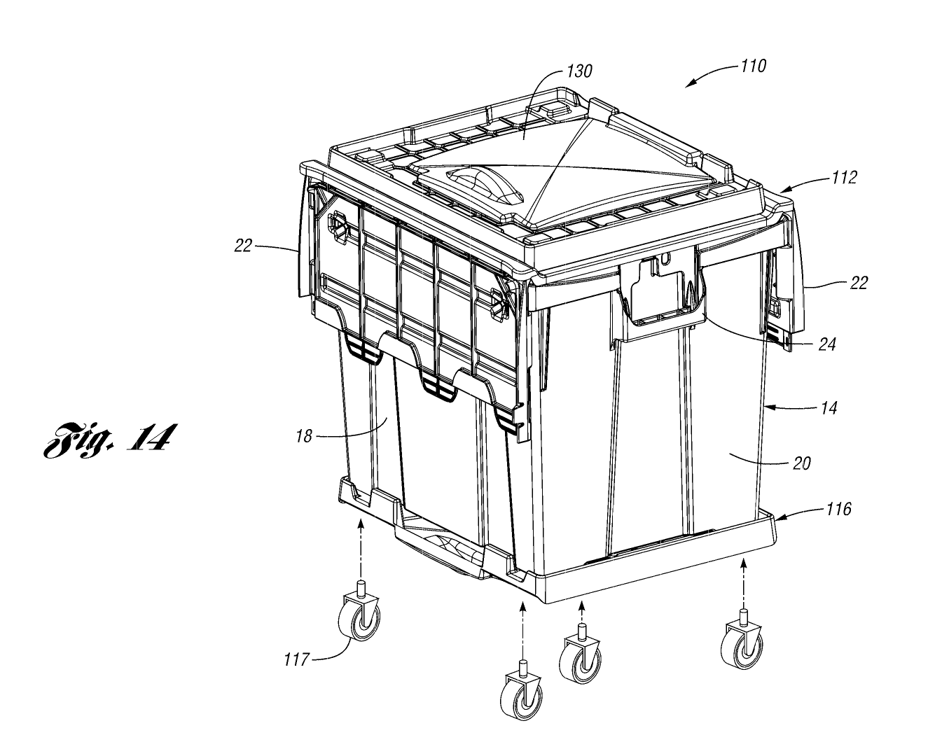

An alternative lid assembly 80 and activation member 92 is shown in FIGS. 11-13 provided on the same container 14 (or optionally, container 14a). The lid assembly 80 includes a secondary lid 82 that sits or snap fits on the upper edges of the container 14. A door 84 is pivotably secured to the secondary lid 82 at pivot points 90 and includes a forward portion 86 and a rearward portion 88. The forward portion 86 is wider than the rearward portion 88, but may be balanced by making the rearward portion 88 thicker. An activation member 92 may be used to pivot the door 84 relative to the secondary lid 82. The activation member includes a lower horizontal portion 94, which can include an offset portion 96 centrally disposed between two side portions 98. The offset portion 96 provides a recess matching the shape of the container 14. The activation member 92 further includes two forward portions 100 extending upwardly having inwardly directed portions 101 (FIG. 12). The inwardly directed portions 101 connect to the rearward portion 88 of the door 84 at a pivoting point 102. Referring specifically to FIG. 13, in use, a user can push down on the offset portion 96 with their foot, thereby causing the rearward portion 88 of the door 84 to pivot downwardly while the forward portion 86 of the door 84 pivots upwardly, thereby providing an opening to the interior of the container 14. Upon releasing the activation member 92, the weight of the forward portion 86 of the door 84 returns the door 84 to the closed position.

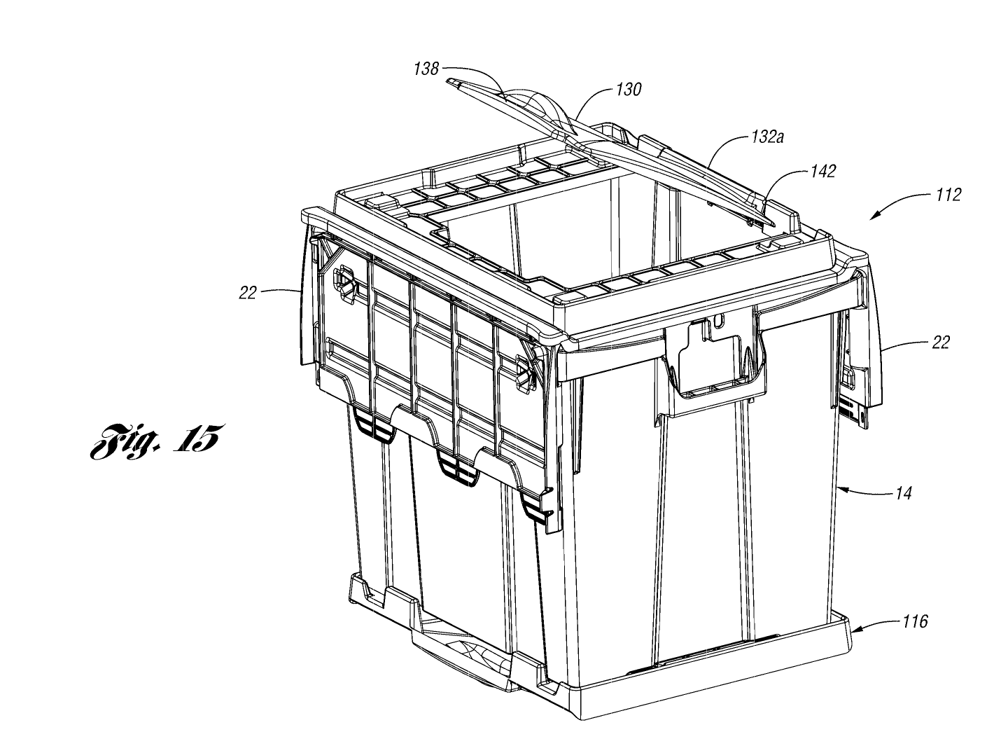

Another example medical waste container system 110 is shown in FIG. 14 including a secondary lid 112 on the same container 14 (or optionally container 14a). The medical waste container system 110 is optionally supported on a base member 116 with optional casters 117. The secondary lid 112 and the base member 116 may be injection molded or thermo-formed. As shown, the secondary lid 112 snap-fits to the upper edges of the container 14 but could alternatively be compression fit, friction fit, simply rest, or otherwise be removably secured on the upper edges of the container 14.

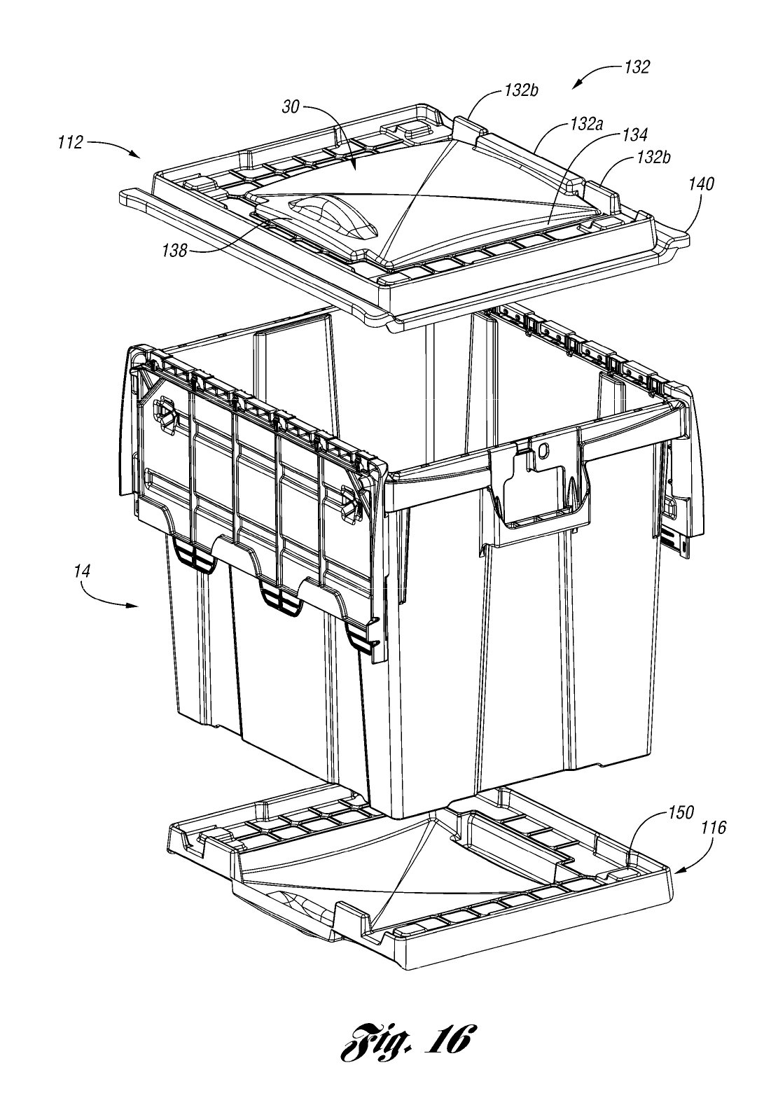

FIG. 15 illustrates the secondary lid 112 with a door 130 in an open position. The door 130 pivots on a hinge pin 142. The door includes a raised hinge portion 132a and a raised handle portion 138. In this embodiment, the door 130 is entirely within the outer edge of the secondary lid 112.

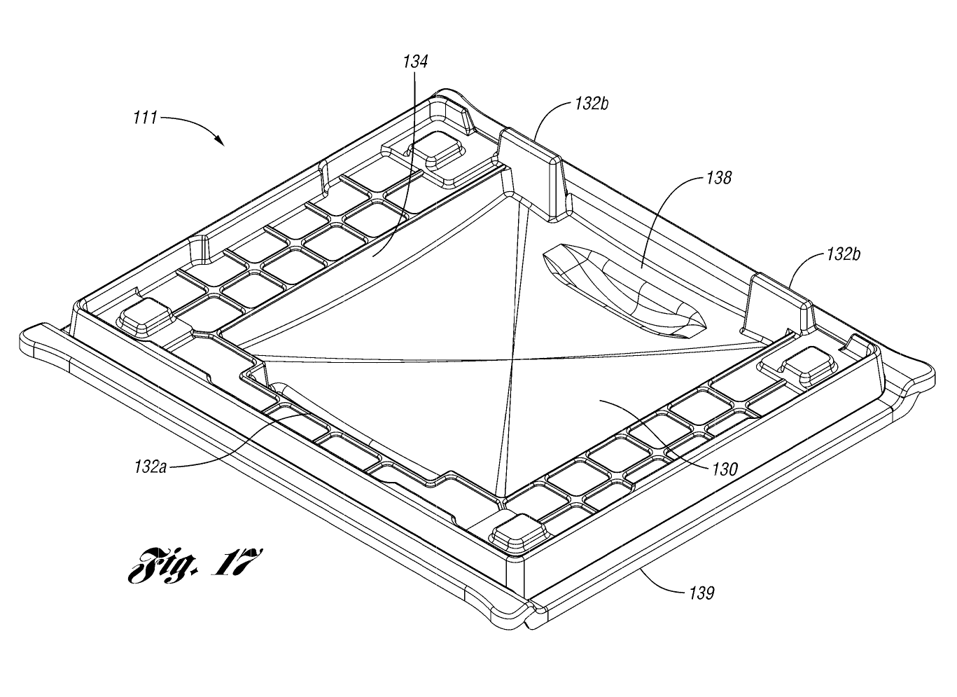

FIG. 16 illustrates at least one protrusion 150 extending from an upper surface of the base member 116 to engage a recess 46 (FIG. 5) on a lower portion of the container 14 to further secure the base member 116 to the container 14. The secondary lid 112 includes a flange 139 that surrounds a perimeter of the secondary lid.

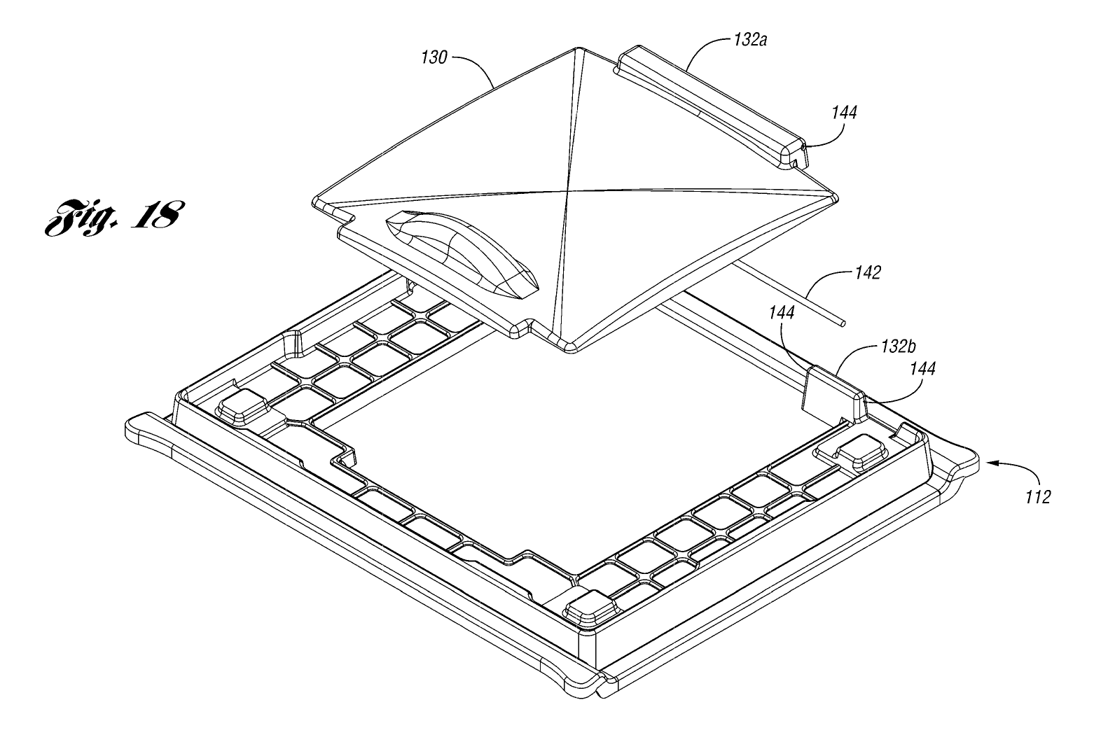

FIG. 17 illustrates a universal member 111. The universal member 111 can be made into either the base member 116 or the secondary lid 112 by trimming or cutting different portions of the universal member 111.

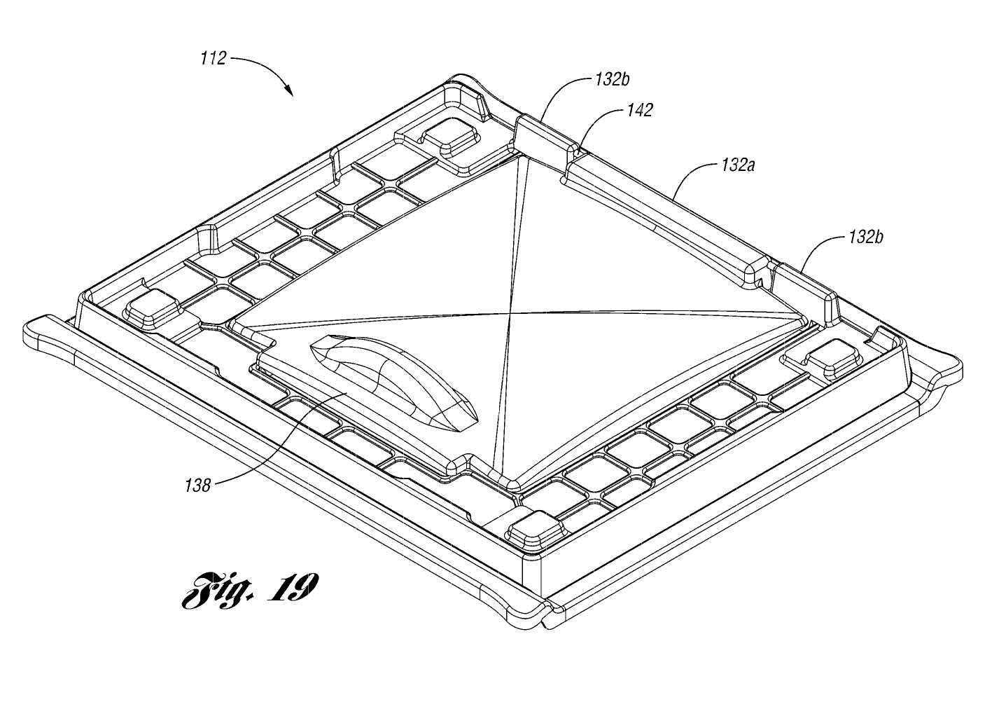

FIG. 18 illustrates an exploded perspective view of the door 130, the hinge pin 142, and the secondary lid 112. The door 130 is trimmed from an interior portion of the universal member 111 (FIG. 17) and flipped about an axis parallel to the hinge portion 132a to attach to the secondary lid 112. The door 130 is attached to the secondary lid 112 by the hinge pin 142. Hinge pin openings 144 extend through the hinge portion 132a on the door 130 and the hinge members 132b on the secondary lid 112. The hinge openings 144 may be formed during molding or drilled in the universal member 111 or the secondary lid 112 and the door 130. A retention device such as a nut, cap, pin, or weld may be applied to the hinge pin 142 to prevent the hinge pin from unintentionally releasing the door 130 from the secondary lid 112. Alternatively, the hinge pin 142 could include a flange at one or both distal ends that would allow the hinge pin 142 to enter the hinge pin openings 144 in a first direction and prevent the hinge pin 142 from exiting the hinge pin openings 144 in a second direction.

FIG. 19 illustrates a top perspective view of the door 130 hingeably attached to the secondary lid 112 in a closed position.

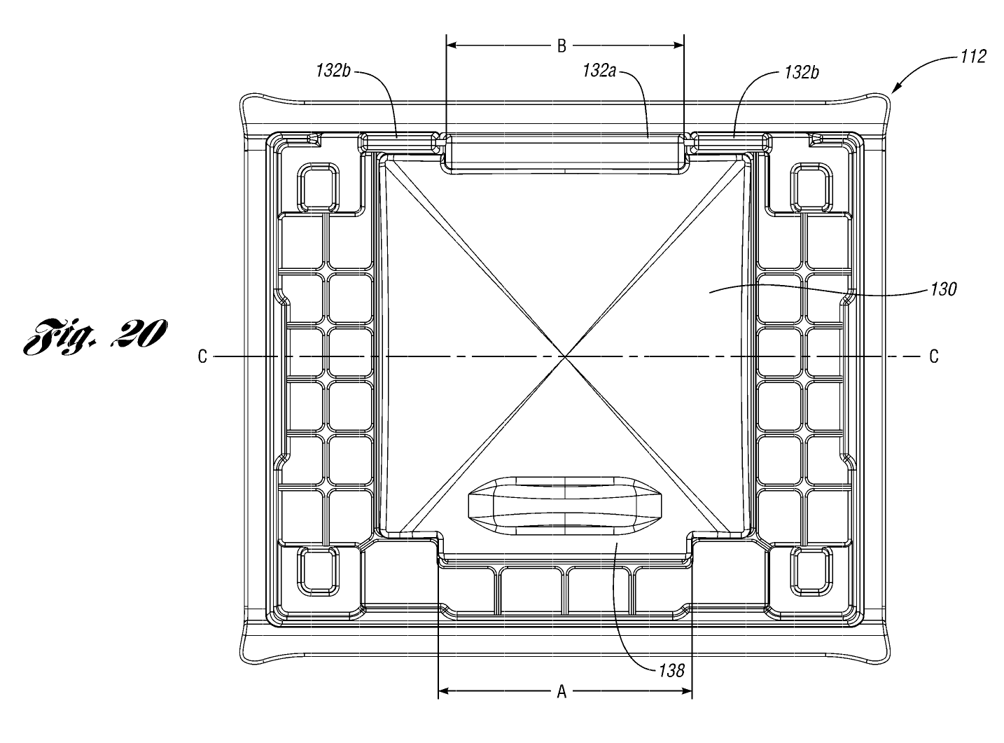

FIG. 20 illustrates a top view of the secondary lid 112 and the door 130. The width A of the handle portion 138 is greater than the width B of the hinge portion 132a. Therefore, when the door 130 is trimmed from the universal member 111 (FIG. 17) and flipped to attach to the secondary lid 112, the handle portion 138 will not pass through the opening formed by trimming the hinge portion 132a from the universal member. Additionally, since the width of the handle portion 138 is greater than the hinge portion 132a, the hinge portion 132a will fit between the hinge members 132b.

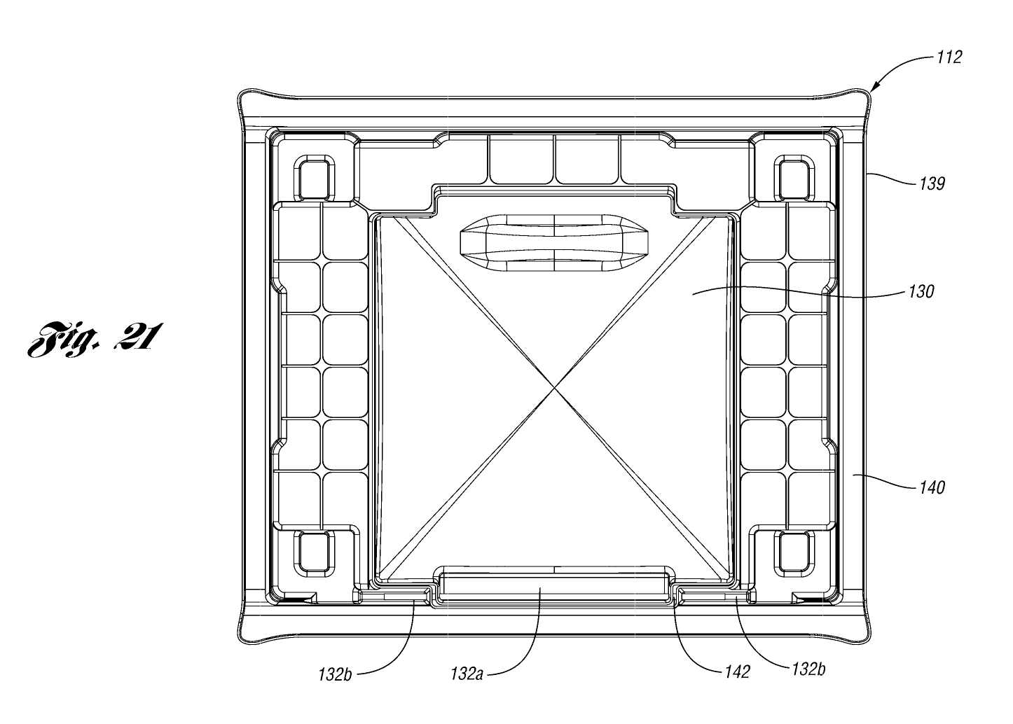

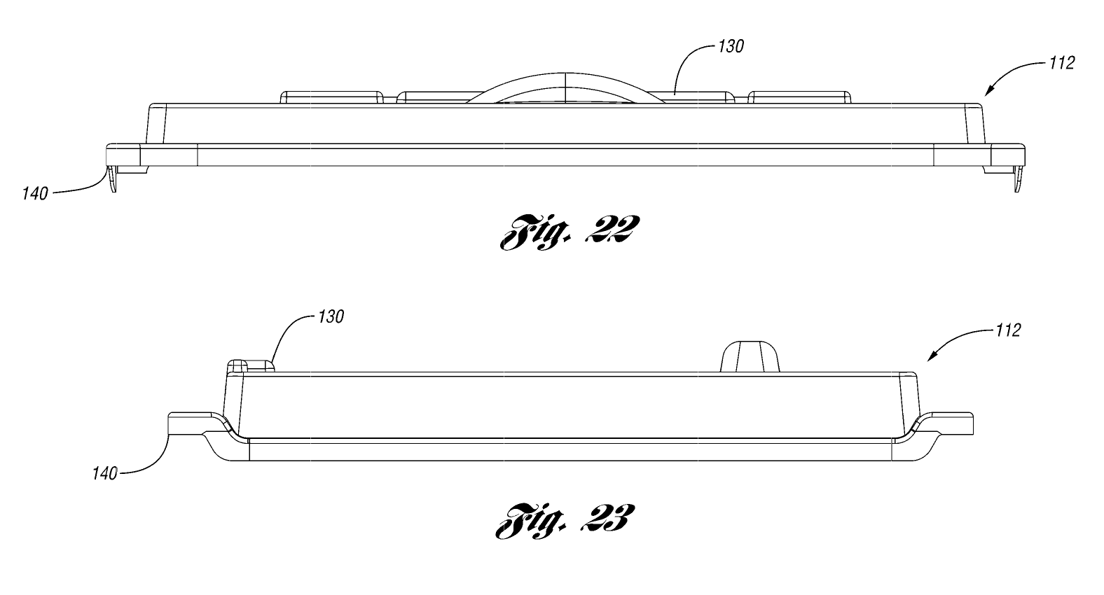

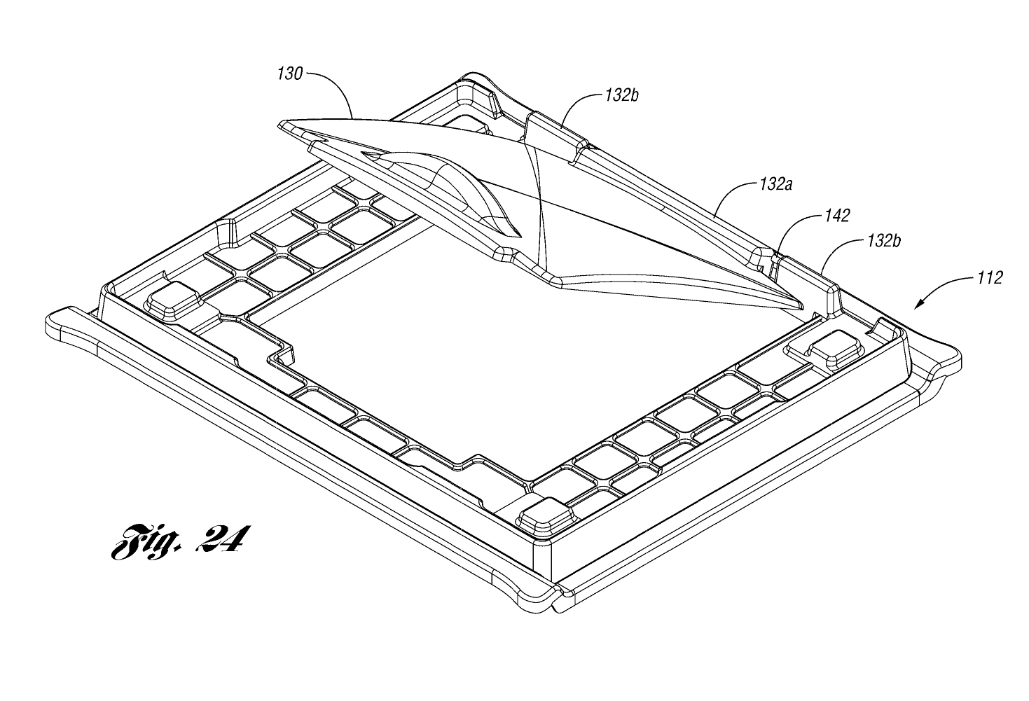

FIG. 21 illustrates a bottom view of the secondary lid 112 and the door 130. The secondary lid 112 includes a channel 140 formed by the flange 139. FIG. 22 illustrates a front view of the secondary lid 112 and the door 130. FIG. 23 illustrates a side view of the secondary lid 112 and the door 130.

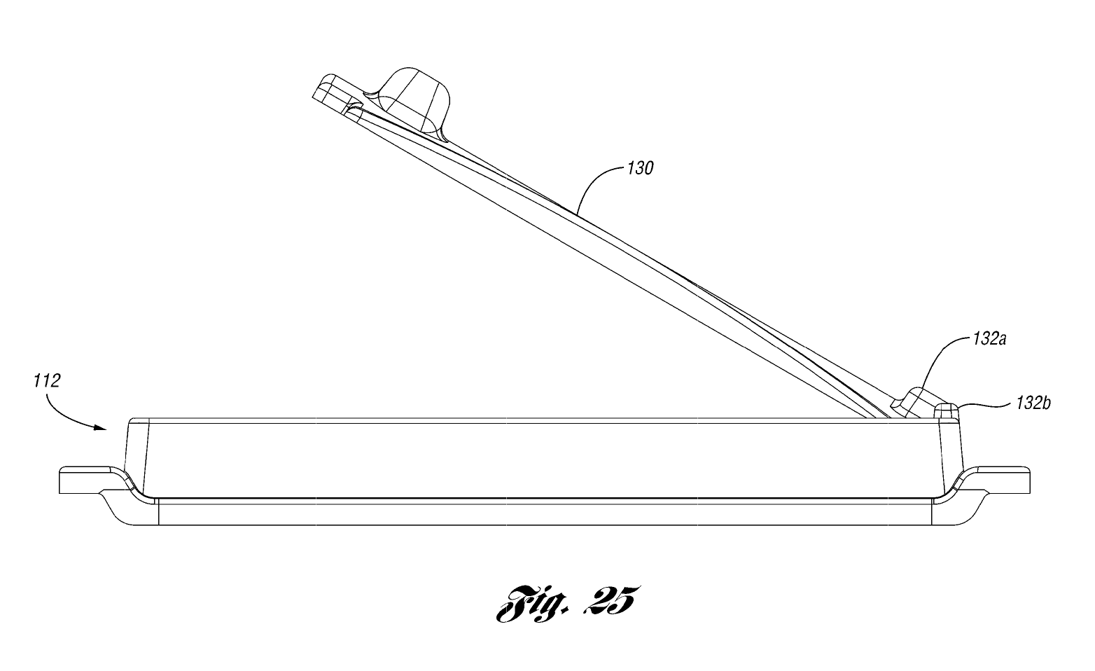

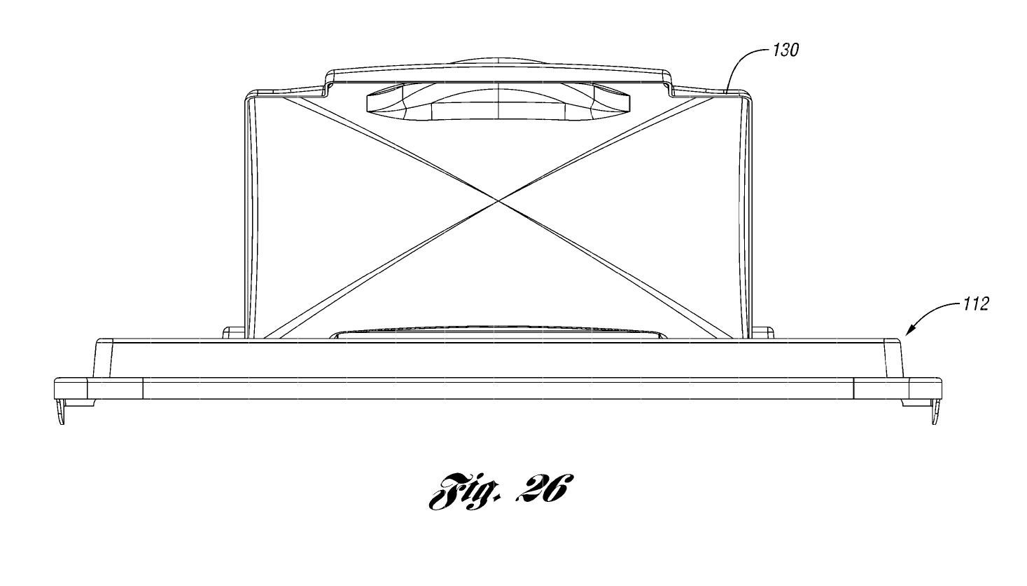

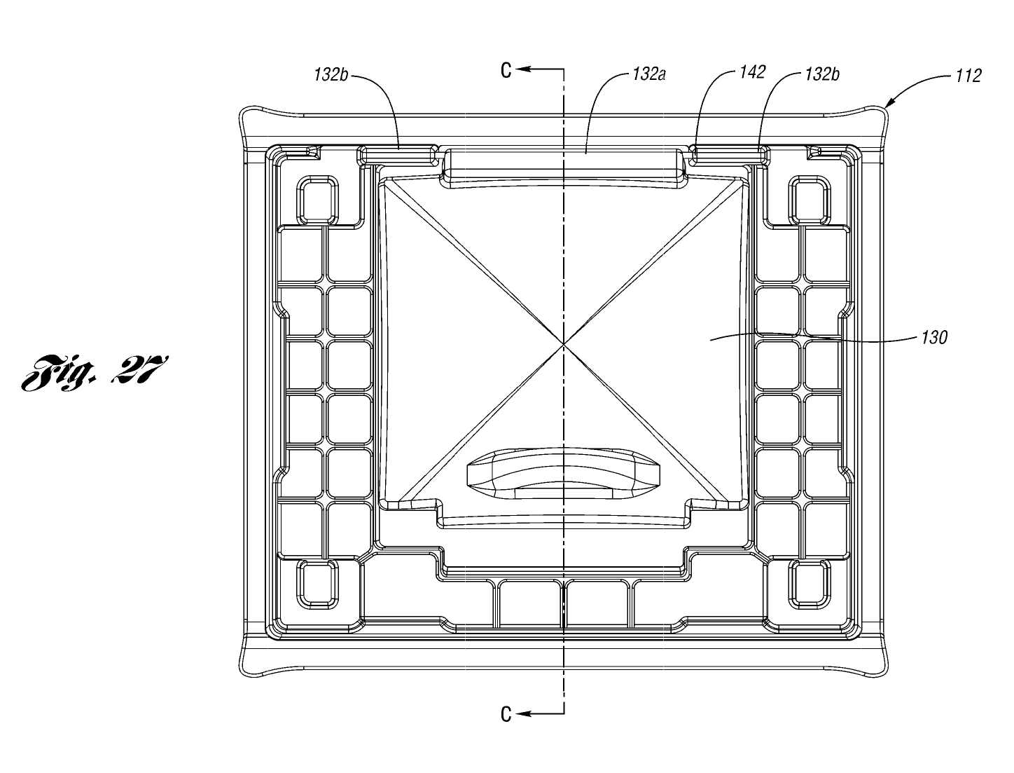

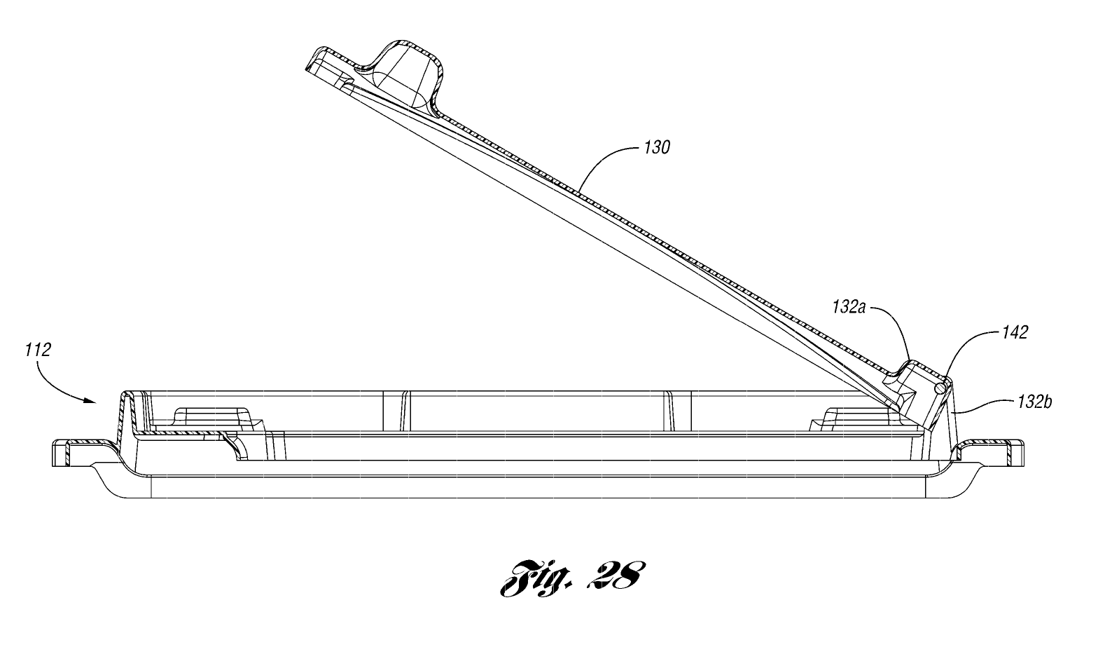

FIG. 24 illustrates a perspective view of the door 130 and the secondary lid 112 with the door 130 in the open position. FIG. 25 illustrates a side view of the door 130 and the secondary lid 112 of FIG. 24. FIG. 26 illustrates a front view of the door 130 and the secondary lid 112 of FIG. 24. FIG. 27 illustrates a top view of the door 130 and the secondary lid 112 of FIG. 24. FIG. 28 illustrates a cross sectional view of the secondary lid 112 and the door 130 taken along line C-C of FIG. 27.

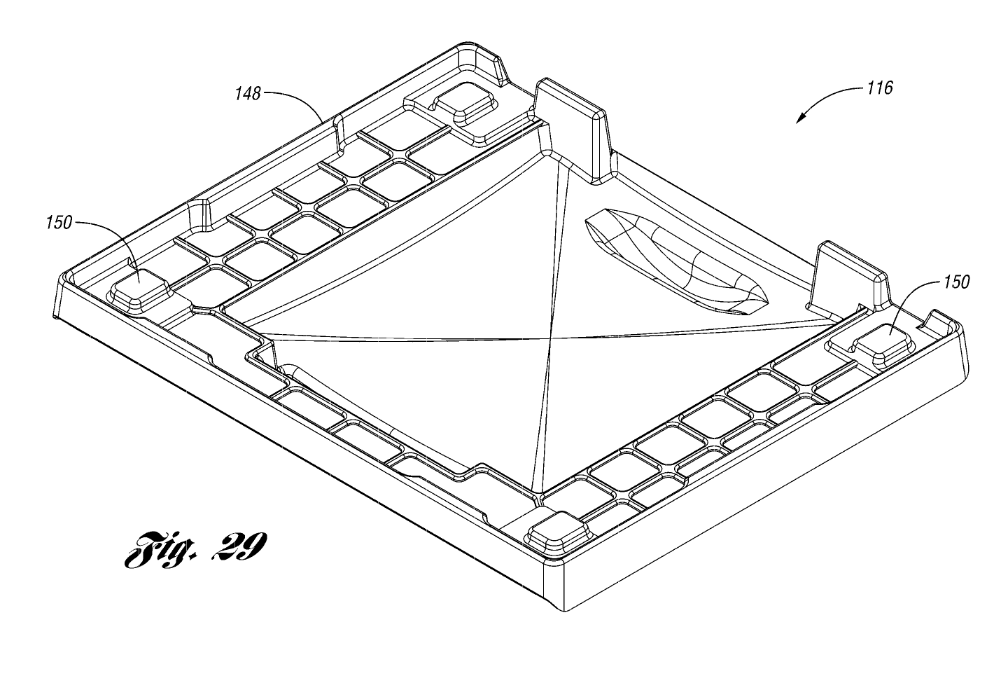

FIG. 29 illustrates the base member 116. The base member 116 includes at least one protrusion 150 and a rim 148 extending upwardly from a perimeter of at least three sides of the base member 116. The rim 148 and the at least one protrusion 150 secure the container 14 to the base member 116 and prevent the container 14 from shifting laterally relative to the base member 116. The base member 116 is produced from the universal member 111 (FIG. 17) by trimming or cutting the flange 139 (FIG. 17) from the universal member 111. Alternatively, the universal member 111 could be used as the base member 116 without any trimming or cutting.

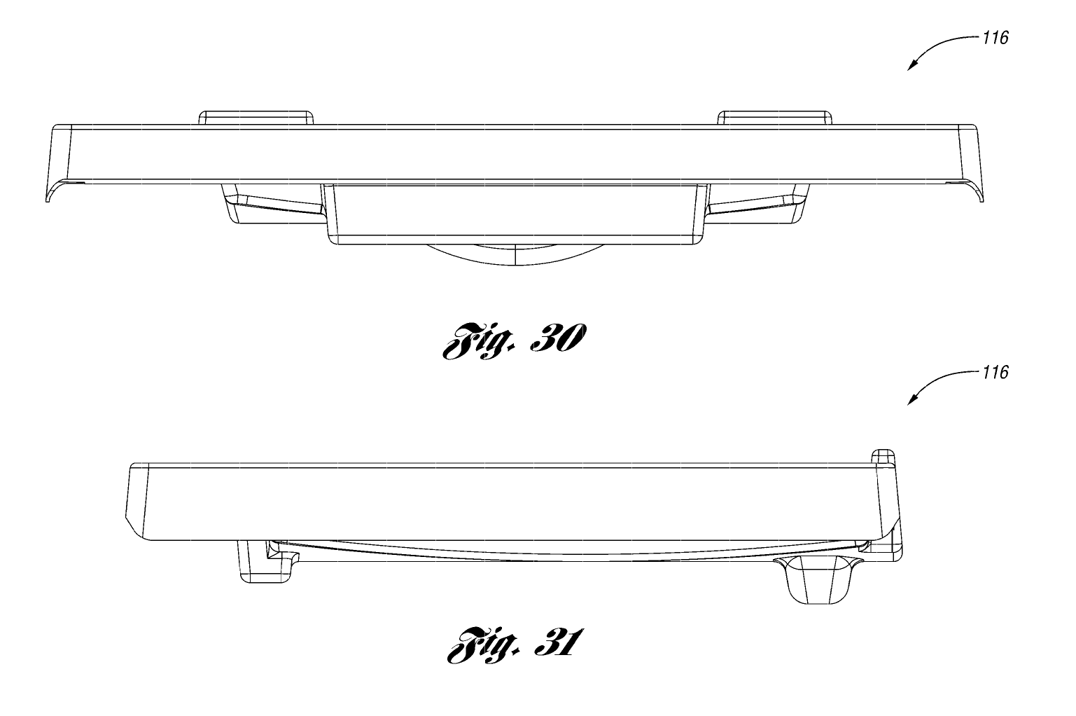

FIG. 30 illustrates a rear view of the base member 116. FIG. 31 illustrates a side view of the base member 116.

The preceding description is exemplary rather than limiting in nature. Variations and modifications to the disclosed examples may become apparent to those skilled in the art that do not necessarily depart from the essence of this disclosure.

We claim:

1. A container assembly comprising:
a container having a base portion and an upper edge; and
a secondary lid located adjacent the upper edge of the container having a door hingeably attached to the secondary lid, wherein the door is trimmed from a portion of the secondary lid.

2. The container assembly of claim 1, wherein the secondary lid and the door are one piece.

3. The container assembly of claim 2, wherein a portion of the door contacts an upper surface of the secondary lid.

4. The container assembly of claim 1, wherein the door pivots on a hinge.

5. The container assembly of claim 1, wherein the door pivots on a hinge pin.

6. The container assembly of claim 1, wherein the door includes a handle located inward from a perimeter of the primary lid.

7. The container assembly of claim 1, wherein the door includes a handle located adjacent a perimeter of the container.

8. The container assembly of claim 1, including a base member adjacent a base portion of the container.

9. The container assembly of claim 8, wherein the base member and the secondary lid are formed from a universal member.

10. The container assembly of claim 1, wherein the door is formed within an outer periphery of the secondary lid.

11. A container assembly comprising:
a container having a base portion and an upper edge;
a secondary lid located adjacent the upper edge of the container having a door hingeably attached to the secondary lid; and
an activation member that engages the door.

12. The container assembly of claim 11, wherein the activation member moves the door between an open and a closed position relative to the secondary lid.

13. The container assembly of claim 11, wherein the activation member engages the door at a location between the activation member's pivotal attachment to the secondary lid and the door's hingable attachment to the secondary lid.

14. The container assembly of claim 11, wherein at least two inwardly extending members on the activation member engage the door.

15. A method of forming a container lid and base member comprising:
a) trimming a first member to produce a lid member; and
b) trimming a second member to produce a base member.

16. The method of forming a container lid and base of claim 15, wherein the first member and the second member are identical.

17. The method of forming a container lid and base of claim 15, wherein step a) further includes the step of forming a door in the first member.

18. A method of forming a container lid comprising:
a) trimming a member to form a door and a lid;
b) rotating the door relative to the lid; and
c) attaching the door to the lid.

19. The method of claim 18, wherein the door is pivotably attached to the lid by a hinge pin.

20. The method of claim 18, wherein the door is trimmed from an inner portion of the member.

21. A container lid comprising:
a lid member; and
a door pivotably attached to the lid member wherein the door is trimmed from a portion of the lid member.

22. The container lid of claim 21, wherein the door and the lid member are connected by a hinge pin.

23. The container lid of claim 21, wherein the door and the lid member are connected by a hinge.

24. The container lid of claim 21, wherein a flange forms a channel around a perimeter of the lid member.

25. The container lid of claim 21, wherein the door is located within a perimeter of the lid member.
